(19) United States
(12) Patent Application Publication
(10) Pub. No.: US 2026/0349999 A1
(43) Pub. Date: Nov. 5, 2026

(54) DATA PREPARATION METHOD, SYSTEM, AND DEVICE FOR AIGC-BASED INTERACTION ANALYSIS, AND MEDIUM

(71) Applicant: INSPUR GENERSOFT CO., LTD., Jinan, Shandong (CN)

(72) Inventors: Weibo ZHENG, Jinan, Shandong (CN); Yiwen WU, Jinan, Shandong (CN); Peng PENG, Jinan, Shandong (CN); Teng LI, Jinan, Shandong (CN); Huabing HAN, Jinan, Shandong (CN); Xiangguo ZHOU, Jinan, Shandong (CN); Chaojun LUO, Jinan, Shandong (CN); Yifan DING, Jinan, Shandong (CN); Weihang ZHENG, Jinan, Shandong (CN)

(21) Appl. No.: 19/485,966

(22) PCT Filed: Jul. 30, 2024
(86) PCT No.: PCT/CN2024/108420

§ 371 Date: Nov. 19, 2025

(30) Foreign Application Priority Data
Apr. 28, 2024 (CN) 202410516640.1

(51) Int. Cl. G06F 16/2452; G06F 16/334; G06F 40/242; G06F 40/284; G06N 3/045

(52) U.S. Cl. CPC G06F 16/24522; G06F 16/3344; G06F 40/242; G06F 40/284; G06N 3/045

(57) ABSTRACT

A data preparation method for AIGC interaction analysis determines a tag sequence corresponding to an interactive sentence after first word segmentation processing by a pre-trained text tag recognition model, determines a tag combination sequence corresponding to the tag sequence and a conditional expression corresponding to the tag combination sequence based on a preset expression construction rule, determines an exact match keyword and a fuzzy match keyword corresponding to the interactive sentence to be subjected to second word segmentation processing by a database candidate text dictionary that is preset and a preset matching rule, determines a word segmentation result corresponding to the second word segmentation processing based on the exact match keyword and a similar candidate text corresponding to the fuzzy match keyword, and generates an interactive SQL query statement corresponding to the conditional expression and the word segmentation result based on a plurality of preset SQL statement rule matching templates.

### CROSS-REFERENCE TO RELATED APPLICATION

This application claims the priority of the Chinese Patent application filed on Apr. 28, 2024 before the CNIPA, China National Intellectual Property Administration with the application number of 202410516640.1, and the title of “DATA PREPARATION METHOD, SYSTEM AND DEVICE FOR AIGC INTERACTION ANALYSIS AND MEDIUM”, which is incorporated herein in its entirety by reference.

### FIELD

The present application relates to the field of electrical digital data processing and more particularly, to a data preparation method, system and device for AIGC interaction analysis and a medium.

### BACKGROUND

Artificial Intelligence Generated Content (AIGC) refers to a technology based on artificial-intelligence technical methods such as generative adversarial networks and large-scale pre-trained models, which generates relevant content with appropriate generalization ability through learning and recognition of existing data.

At present, conversational BI products of AIGC such as ChatBI in Business Intelligence (BI) applications may recognize and understand natural language questions of users, and achieve interaction with the users. However, the current conversational BI products still have limited ability to understand the questions asked by the users.

When understanding natural language by the conversational BI products, it usually includes an understanding process of segmenting the natural language and matching the keywords extracted through word segmentation with fields in the database. For the word segmentation, four methods such as word segmentation based on rule matching, word segmentation based on statistical methods, word segmentation based on deep learning, and word segmentation based on large model fine-tuning are mostly used in the industry. In practical use, the inventor found that the segmentation results obtained by these four methods have problems such as language recognition ambiguity, inability to directly apply to converting structured query language (SQL), and inability to accurately generate SQL statements with complex logic, which makes the conversational BI products still at a low level of intelligence.

### SUMMARY

To solve the above problems, the embodiments of the present application provide a data preparation method, system and device for AIGC interaction analysis, and a medium.

On the one hand, the embodiment of the present application provides a data preparation method for AIGC interaction analysis, and the method includes:
determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation;
determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression;
determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation;
determining a word segmentation result corresponding to the second word segmentation processing based on the exact match keyword and a similar candidate text corresponding to the fuzzy match keyword; and
generating an interactive SQL query statement corresponding to the conditional expression and the word segmentation result based on a plurality of preset SQL statement rule matching templates, to determine interactive response information corresponding to the interactive sentence based on the interactive SQL query statement.

In an embodiment of the present application, before determining, by a pre-trained text tag recognition model, a tag sequence corresponding to an interactive sentence after first word segmentation processing, the method further includes:
acquiring a text normalization mapping table that is pre-constructed;
after receiving the interactive sentence from a user terminal, determining a text to be normalized in the interactive sentence and mapping a text format of the text to be normalized to a standardized format through the text normalization mapping table, to obtain the interactive sentence in the standardized format; wherein the standardized format includes at least a numeric standardized format, a temporal standardized format, a punctuation standardized format, and a reserved part-of-speech standardized format.

In an embodiment of the present application, before determining, by a pre-trained text tag recognition model, a tag sequence corresponding to an interactive sentence after first word segmentation processing, the method further includes:
acquiring a statement training sample set that is pre-constructed; wherein the statement training sample set includes at least a plurality of interactive sentence samples and their corresponding SQL query statements, and each of the plurality of interactive sentence samples is pre-annotated with the preset tags used to form the conditional expression;
inputting the plurality of interactive sentence samples in the statement training sample set into a text tag recognition model to be trained, so that the text tag recognition model to be trained performs the first word segmentation processing on each of the plurality of interactive sentence samples by its BERT model, and outputs sample prediction tag sequences corresponding to interactive sentence samples after the first word segmentation processing by an output layer; and
determining a difference degree value between each of the sample prediction tag sequences and a corresponding true tag sequence by a cross-entropy loss function, until the difference degree value is less than a preset threshold, to obtain a trained text tag recognition model.

In an embodiment of the present application, determining an exact match keyword and a fuzzy match keyword corresponding to the interactive sentence to be subjected to second word segmentation processing by a database candidate text dictionary that is preset and a preset matching rule includes:
performing the second word segmentation processing on the interactive sentence by a HanLP tokenizer, and identifying the second text segmentation that is consistent with the candidate text by the database candidate text dictionary;
performing part-of-speech annotation on the second text segmentation that is consistent with the candidate text based on a pre-annotated part of speech corresponding to the candidate text, to obtain the exact match keyword; and
regarding second text segmentation that is inconsistent with any candidate text as the fuzzy match keyword.

In an embodiment of the present application, determining a word segmentation result corresponding to the second word segmentation processing based on the exact match keyword and a similar candidate text corresponding to the fuzzy match keyword includes:
converting, by a pre-trained word vector model, the fuzzy match keyword into a keyword vector;
calculating a text similarity between the keyword vector and a candidate text vector corresponding to each candidate text, and using the text similarity as an input value to input into a preset hierarchical clustering algorithm, to determine a similar candidate text set corresponding to the fuzzy match keyword;
filtering each candidate text pair generated from the similar candidate text set and the fuzzy match keyword by a preset filtering rule, to obtain the similar candidate text corresponding to the fuzzy match keyword; and
based on the similar candidate text and its corresponding pre-annotated part of speech, as well as the exact match keyword, determining the word segmentation result after performing the second word segmentation processing on the interactive sentence; wherein the word segmentation result includes a query candidate text and its part of speech, and the part of speech includes at least a field and a value.

In an embodiment of the present application, the preset hierarchical clustering algorithm is an Average-Linkage clustering algorithm.

In an embodiment of the present application, generating an interactive SQL query statement corresponding to the conditional expression and the word segmentation result based on a plurality of preset SQL statement rule matching templates includes:
determining the plurality of preset SQL statement rule matching templates based on a pre-defined operation of a user; wherein one of the plurality of preset SQL statement rule matching templates corresponds to one database query type, and each of the plurality of preset SQL statement rule matching templates includes a slot to be filled for inserting content constituting a database query statement; and
based on the conditional expression and the word segmentation result, matching a corresponding preset SQL statement rule matching template, and filling a corresponding slot to be filled, to obtain the interactive SQL query statement; wherein the conditional expression includes a query condition corresponding to the interactive SQL query statement, and the word segmentation result includes a query candidate text corresponding to the query condition and used to construct the interactive SQL query statement.

On the other hand, an embodiment of the present application provides a data preparation system for AIGC interaction analysis, including:
a tag sequence determination module, configured for determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation;
a conditional expression determination module, configured for determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression;
a keyword determination module, configured for determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation;
a word segmentation result determination module, configured for determining a word segmentation result corresponding to the second word segmentation processing based on the exact match keyword and a similar candidate text corresponding to the fuzzy match keyword; and
a statement generation module, configured for generating an interactive SQL query statement corresponding to the conditional expression and the word segmentation result based on a plurality of preset SQL statement rule matching templates, to determine interactive response information corresponding to the interactive sentence based on the interactive SQL query statement.

On yet another hand, an embodiment of the present application provides a data preparation device for AIGC interaction analysis, including:
at least one processor; and a memory connected in communication with the at least one processor; wherein the memory stores an instruction that is capable of being executed by the at least one processor, and the instruction, when executed by the at least one processor, causes the at least one processor to perform operations including:
determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation;
determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression;
determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation;
determining a word segmentation result corresponding to the second word segmentation processing based on the exact match keyword and a similar candidate text corresponding to the fuzzy match keyword; and
generating an interactive SQL query statement corresponding to the conditional expression and the word segmentation result based on a plurality of preset SQL statement rule matching templates, to determine interactive response information corresponding to the interactive sentence based on the interactive SQL query statement.

On yet another hand, an embodiment of the present application provides a non-transitory computer storage medium, storing a computer-executable instruction, wherein the computer-executable instruction is configured for:
determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation;
determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression;
determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation;
determining a word segmentation result corresponding to the second word segmentation processing based on the exact match keyword and a similar candidate text corresponding to the fuzzy match keyword; and
generating an interactive SQL query statement corresponding to the conditional expression and the word segmentation result based on a plurality of preset SQL statement rule matching templates, to determine interactive response information corresponding to the interactive sentence based on the interactive SQL query statement.

Compared with the prior art, the significant effects of the present application are as follows:

Through the above solution, the present application may achieve accurate word segmentation processing of the natural language, ensuring that the interactive sentence may be successfully matched with fields or values in the database. At the same time, identifying conditional expressions in the interactive sentence and their corresponding fields or values in the database may ensure the accuracy of generated interactive SQL query statements and effectively convert the natural language into executable SQL statements. It may also avoid question ambiguity when converting into the SQL statements, and achieve generation of SQL statements with complex logic, providing sufficient data preparation conditions for AIGC interaction analysis.

### BRIEF DESCRIPTION OF THE DRAWINGS

The accompanying drawings described herein are intended to provide further understanding of the present application and constitute a part of the present application. The illustrative embodiments of the present application and their descriptions are used to explain the present application and do not constitute undue limitation of the present application. In the accompanying drawings:

FIG. 1 is a flow chart of a data preparation method for AIGC interaction analysis according to an embodiment of the present application;

FIG. 2 is a schematic diagram of the natural language response process corresponding to a data preparation method for AIGC interaction analysis according to an embodiment of the present application;

FIG. 3 is a schematic structural diagram of a data preparation system for AIGC interaction analysis according to an embodiment of the present application; and

FIG. 4 is a schematic structural diagram of a data preparation device for AIGC interaction analysis according to an embodiment of the present application.

### DETAILED DESCRIPTION

In order to clarify the purpose, technical solution, and advantages of the present application, the following will provide a clear and complete description of the technical solution of the present application in conjunction with specific embodiments and corresponding drawings. Obviously, the described embodiments are only a part of the embodiments of the present application, not all embodiments. Based on the embodiments in the present application, all other embodiments obtained by persons skilled in the art without creative labor are within the scope of protection of the present application.

The existing conversational BI products still have limited ability to understand the questions asked by the users. The basis for converting the natural language into effective executable SQL lies in the ability to correctly and reasonably segment the natural language, thereby successfully matching extracted keywords with the fields or the values in the database. There are four main methods for natural language word segmentation technology in the industry, and each of these methods still has certain shortcomings and implementation difficulties:

1. The word segmentation based on rule matching: it relies on pre-defined dictionaries and grammar rules to identify and segment words in text, which is easy to implement. It performs well for some structurally fixed and formatted texts, but has weak recognition ability for new words and limited ability to handle a sentence with ambiguity and complex structure.

2. The word segmentation based on statistical methods: by counting the co-occurrence information of words in the corpus, the boundary probability of the words is calculated. It does not rely entirely on the dictionaries and may recognize new words to a certain extent. However, it requires a large amount of annotated data for model training, which has poor adaptability to changes in language usage habits. Moreover, the accuracy of word segmentation is limited by the quality and coverage of training data.

3. The word segmentation based on deep learning: it may better understand contextual and semantic information, has stronger ability to handle ambiguous words, and usually does not require manual designed features. The model may automatically learn features from data, but the model has a strong dependence on the training data, and the data quality directly affects the word segmentation effect.

4. The word segmentation based on large model fine-tuning: it may utilize the powerful language understanding ability of large models to more accurately handle complex texts and ambiguous words. The shortcoming is that it also requires a large amount of computing resources, and needs to collect user questions as fine-tuning training databases and annotate data. The data sources are limited, with a single field, and the acquisition is highly difficult. The trained large model is still only effective for natural language questioning in this field.

Simply using the above four methods is still not suitable for converting SQL, eliminating question ambiguity, and generating SQL statements with complex logic.

Based on this, the embodiment of the present application provides a data preparation method, system and device for AIGC interaction analysis, and a medium, which is used to solve the current problems where natural language word segmentation is not accurate enough, resulting in language recognition ambiguity in segmentation results, inability to be directly applied to SQL conversion, and inability to accurately generate SQL statements with complex logic.

The various embodiments of the present application will be described in detail with reference to the accompanying drawings.

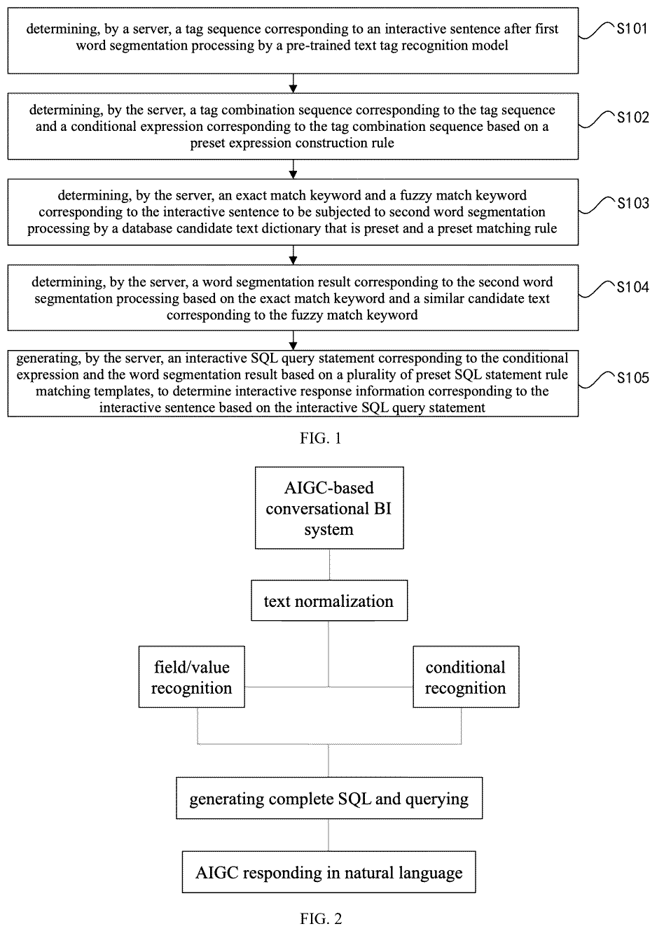

The embodiment of the present application provides a data preparation method for AIGC interaction analysis, as shown in FIG. 1, the method may include steps S101-S105:

S101, determining, by a server, a tag sequence corresponding to an interactive sentence after first word segmentation processing by a pre-trained text tag recognition model.

Among them, the tag sequence includes preset tags that are arranged according to a word order of the interactive sentence and correspond to first text segmentation.

It should be noted that the server, as the executing entity of the data preparation method for AIGC interaction analysis, is cited merely as an example, and the executing entity is not limited to the server. The present application does not make specific limitations on this.

The text tag recognition model may process and recognize the interactive sentence, and output a tag sequence corresponding to the interactive sentence. For example, if the interactive sentence is “find employees whose age is greater than 30 years old”, the text tag recognition model annotates “age” as the preset tag: field name (F), annotates “greater than” as the preset tag: operator (O), and annotates “30 years old” as the preset tag: value (V). The preset tag may be understood as a component of the conditional expression, which may include at least the field name, the operator, and the value. It may be set by the user based on the actual usage scenario, and the present application does not make specific limitations on it. The text tag recognition model may be a BERT model (BERT-Base-Chinese pre-trained model based on Transformer) with an output layer added that is suitable for a sequence annotation task, where the sequence annotation task refers to annotating the first text segmentation output by a tokenizer of the BERT model with the preset tags. The output layer may be a fully connected layer, and its output dimension is equal to the number of preset tags annotated in the sequence annotation task (e.g., including the field name, the operator, and the value).

For the pre-training process of the above text tag recognition model, reference may be made to the following embodiments. In some embodiments, before determining, by a pre-trained text tag recognition model, a tag sequence corresponding to an interactive sentence after first word segmentation processing, the method further includes:
acquiring, by the server, a statement training sample set that is pre-constructed. Among them, the statement training sample set includes at least a plurality of interactive sentence samples and their corresponding SQL query statements, and each of the plurality of interactive sentence samples is pre-annotated with the preset tags used to form the conditional expression. Subsequently, the plurality of interactive sentence samples in the statement training sample set are input into a text tag recognition model to be trained, so that the text tag recognition model to be trained performs the first word segmentation processing on each of the plurality of interactive sentence samples by its BERT model, and outputs sample prediction tag sequences corresponding to interactive sentence samples after the first word segmentation processing by an output layer. And then, a difference degree value between each of the sample prediction tag sequences and a corresponding true tag sequence is determined by a cross-entropy loss function, until the difference degree value is less than a preset threshold, to obtain a trained text tag recognition model.

In other words, a statement training sample set including interactive sentence samples and their corresponding SQL query statements may be pre-constructed, and the components of the conditional expression such as the field name, the operator, and the value may be annotated for each interactive sentence sample. Among them, the interactive sentence in the present application may be understood as the natural language input by the user into the server. The server uses the statement training sample set to pre-train the text tag recognition model.

During the pre-training process, the tokenizer of the BERT model is first used to perform the first word segmentation processing on the interactive sentence samples, and the segmented text is converted into an input format that the model may understand, such as the numerical ID sequence of the vocabulary. At the same time, the annotations corresponding to the segmented text may be converted into corresponding sample prediction tag sequences, which may be output using the output layer. In this process, the server uses the cross-entropy loss function to train the model, this function calculates the difference between the sample prediction tag sequences output by the model and the true tag sequence. This difference is quantified as the difference degree value through the function value of the cross-entropy loss function. When the difference degree value is less than the preset threshold set by the user in advance, the training of the text tag recognition model is completed.

In another embodiment of the present application, the interactive sentences typically includes non-standard words and expressions, which will affect the word segmentation and recognition understanding of subsequent interactive sentences. Therefore, before determining, by a pre-trained text tag recognition model, a tag sequence corresponding to an interactive sentence after first word segmentation processing, the method further includes:
acquiring, by the server, a text normalization mapping table that is pre-constructed; after receiving the interactive sentence from a user terminal, determining a text to be normalized in the interactive sentence and mapping a text format of the text to be normalized to a standardized format through the text normalization mapping table, to obtain the interactive sentence in the standardized format. The standardized format includes at least a numeric standardized format, a temporal standardized format, a punctuation standardized format, and a reserved part-of-speech standardized format.

That is to say, in order to normalize the input interactive sentences and convert them into a form that is easier for machines to understand and process, the text normalization mapping table may be pre-constructed. By this text normalization mapping table, after receiving non-normalized interactive sentences, the text normalization mapping may be performed first, followed by operations such as the first word segmentation processing and the second word segmentation processing. Among them, the text normalization mapping may map the interactive sentences to standardized formats such as the numeric standardized format, the temporal standardized format, the punctuation standardized format, and the reserved part-of-speech standardized format. Among them, the numerical normalization may refer to mapping “ten thousand yuan” to “10000 yuan”, which may map Chinese numbers and quantifiers (such as “one”, “ten thousand”, “thousand”, etc.) to corresponding numerical values. By parsing and calculating the numerical values and quantifiers in the expression, they may be converted into standard numerical representations. The temporal normalization may refer to mapping from “May 1, 2023” to “2023-05-01”, the temporal normalization usually requires parsing the time expression in natural language and then converting it into a standard format (such as ISO 8601). The server may also recognize different date formats through regular expressions, or use specialized libraries (such as dateutil.parser in Python) to parse date expressions in natural language. Among them, for expressions involving relative time (such as “next year”, “next month”, etc.), the actual date may be calculated based on the current date context. For the standardized format of tag symbols, punctuation cleaning may be included. The reserved part-of-speech standardized format may be achieved by using part-of-speech annotation technology, which removes modal particles and function words such as “please help me query”, “ne” (this modal particle is pronounced as “ne” in Chinese), “which” and other parts of speech in the text.

Through the above text normalization processing, it is easier to segment normalized text, which may enable the natural language to be efficiently and accurately converted into the SQL statements, thus improving the computation speed and intelligence level of the conversational BI products.

S102, determining, by the server, a tag combination sequence corresponding to the tag sequence and a conditional expression corresponding to the tag combination sequence based on a preset expression construction rule.

The above preset expression construction rules are used to combine a plurality of preset tags in the tag sequence and obtain the tag combination sequence. Each tag combination sequence has a unique corresponding conditional expression.

In the embodiments of the present application, the server may be pre-set with the preset expression construction rules, the preset expression construction rules include the association relationship between the tag combination sequence obtained by combining different preset tags and different conditional expressions. For example, after being processed by the text tag recognition model, the output tag sequence of one interactive sentence is a tag sequence consisting of continuous annotations of the field name, the operator, and the value [field name, operator, value]. By the preset expression construction rules, it may be determined that the tag sequence has a unique corresponding conditional expression, that is, the tag sequence may form a conditional expression for subsequent conversion into SQL to query the content to be queried corresponding to this conditional expression. A more intuitive understanding of a conditional expression is, for example, age—greater than—30 years old, which is a conditional expression.

The above solution of the present application is based on deep learning for model training. By using the trained text tag recognition model, the conditional expressions included in the interactive sentences may be accurately and efficiently obtained, providing support for generating accurate interactive SQL query statements in the future.

S103, determining, by the server, an exact match keyword and a fuzzy match keyword corresponding to the interactive sentence to be subjected to second word segmentation processing by a database candidate text dictionary that is preset and a preset matching rule.

Among them, the preset matching rule is used to match a candidate text in the database candidate text dictionary that is consistent with second text segmentation.

The preset database candidate text dictionary may be constructed from all table names, fields, and values in the database. The server may traverse all tables in the database, extract the table names, the field names, and non-numeric cell values, and perform deduplication on the cell values. The server may organize all the collected information based on the dictionary format required by the HanLP tokenizer, including each vocabulary and its part of speech (for the content in the database, the part of speech may be customized, such as the table name is table, the field name is field, and the cell value is value, etc.), thus obtaining the database candidate text dictionary including several candidate texts. The candidate text may be the field or the value, and the present application does not limit it.

After pre-setting the database candidate text dictionary, in the present embodiment of the application, determining an exact match keyword and a fuzzy match keyword corresponding to the interactive sentence to be subjected to second word segmentation processing by a database candidate text dictionary that is preset and a preset matching rule includes:
performing, by the server, the second word segmentation processing on the interactive sentence by a HanLP tokenizer, and identifying the second text segmentation that is consistent with the candidate text by the database candidate text dictionary; performing part-of-speech annotation on the second text segmentation that is consistent with the candidate text based on a pre-annotated part of speech corresponding to the candidate text, to obtain the exact match keyword; and regarding second text segmentation that is inconsistent with any candidate text as the fuzzy match keyword.

That is to say, the server may use the Chinese language processing package tool, such as the HanLP tokenizer, to perform the second word segmentation processing on the interactive sentence. The second word segmentation processing may be performed on the interactive sentence after text normalization processing. During the second word segmentation processing, the tokenizer may use the database candidate text dictionary to identify the second text segmentation that is consistent with the candidate text, and perform part-of-speech annotation on the second text segmentation to obtain the exact match keywords. The second text segmentation that did not successfully match the candidate text in the database candidate text dictionary is used as the fuzzy match keyword.

For example, the interactive sentence without the text normalization processing is “What is the total trading volume of stocks whose primary industry is non-silver finance”, the database candidate text dictionary includes “primary industry”, “non-bank finance”, “stocks”, and “trading volume”. Among them, the “primary industry”, “stock”, and “trading volume” in the interactive sentence may be recognized by the HanLP tokenizer and extracted, annotated as “fields”, which are the exact match keywords. However, there is no consistent candidate text for “non-silver finance” in the database candidate text dictionary (which is not completely consistent with “non-bank finance”), and it will be returned as the fuzzy match keyword.

S104, determining, by the server, a word segmentation result corresponding to the second word segmentation processing based on the exact match keyword and a similar candidate text corresponding to the fuzzy match keyword.

In the embodiment of the present application, determining a word segmentation result corresponding to the second word segmentation processing based on the exact match keyword and a similar candidate text corresponding to the fuzzy match keyword includes:
firstly, processing the fuzzy match keyword to determine their corresponding similar candidate texts. In some embodiments, the fuzzy match keyword is converted into a keyword vector by a pre-trained word vector model. A text similarity between the keyword vector and a candidate text vector corresponding to each candidate text is calculated, and the text similarity is used as an input value to input into a preset hierarchical clustering algorithm, to determine a similar candidate text set corresponding to the fuzzy match keyword. Each candidate text pair generated from the similar candidate text set and the fuzzy match keyword is filtered by a preset filtering rule, to obtain the similar candidate text corresponding to the fuzzy match keyword.

Among them, when determining the similar candidate text, the server may use word vector models such as Word2Vec, GloVe, BERT, etc. to convert the fuzzy match keywords into vector representations to obtain keyword vectors. Next, the text similarity between the keyword vector and the candidate text vectors of each candidate text in the database candidate text dictionary may be calculated. The text similarity may be cosine similarity, and the formula is as follows:

$$cost = \frac{{\sum }_{x = 1}^{y} ( {A}_{x} \times {B}_{x} )}{\sqrt{{\sum }_{x = 1}^{y} {( {A}_{x} )}^{2}} \times \sqrt{{\sum }_{x = 1}^{y} {( {B}_{x} )}^{2}}}$$

Among them, cos t is the cosine similarity between the keyword vector A and the candidate text vector B, Aₓ represents the component of the keyword vector A, Bₓ represents the component of the candidate text vector B, and y is the total amount of vector components.

After obtaining the text similarity, the server may take it as input and use the hierarchical clustering algorithm for clustering analysis. In the embodiment of the present application, the hierarchical clustering algorithm may be the Average-Linkage clustering algorithm. During the clustering analysis, an average distance between all possible point pairs between clusters may be calculated, and the two clusters with the minimum distance may be selected for merging. In this process, the candidate texts may be grouped with the fuzzy match keywords based on the text similarity, in order to obtain candidate text pairs composed of semantically similar vocabulary combinations, forming the similar candidate text set.

Furthermore, the server may apply record linking technology to identify and link the best matching items in the similar candidate text set. In some embodiments, it may be achieved by setting a similarity threshold, where candidate text pairs exceeding this similarity threshold are considered valid matches, and one or more candidate text pairs are filtered out. Next, the preset filtering rule may be used to obtain a candidate text pair, which may determine the candidate text that best matches the fuzzy match keyword as the similar candidate text. The preset filtering rule may be to select the matching item with the highest text similarity, combine domain knowledge for rule-based solutions, etc., and the present application does not make specific limitations on this.

When determining the similar candidate texts, the Average-Linkage clustering algorithm takes into account both the compactness within the clusters and avoids excessive diffusion caused by a single outlier (such as possible situations caused by Single-Linkage) or overly strict clustering (such as possible situations caused by Complete-Linkage). By using the record linking technology, the system may automatically identify the fuzzy match keywords and match them with the most relevant fields or values in the database when processing the interactive sentences. Even if there are synonyms, spelling errors, and other situations, it may achieve high matching accuracy, thereby improving query understanding and processing capabilities.

Subsequently, based on the similar candidate texts and their corresponding pre-annotated parts of speech, and exact match keywords, the word segmentation result after performing the second word segmentation processing on the interactive sentence is determined. The word segmentation result includes a query candidate text and its part of speech, and the part of speech includes at least a field and a value.

In other words, after obtaining the similar candidate text, the server may segment the fuzzy match keywords and perform part-of-speech annotation by segmenting the exact match keywords as described above, to obtain the word segmentation result. The word segmentation result includes the fields or values in the database corresponding to each word in the interactive sentence.

Through the above solution, accurately word segmentation processing may be performed on the interactive sentence to obtain the fields or values in the database corresponding to the interactive sentence, which facilitates the conversion into the SQL statements for querying.

S105, generating, by the server, an interactive SQL query statement corresponding to the conditional expression and the word segmentation result based on a plurality of preset SQL statement rule matching templates, to determine interactive response information corresponding to the interactive sentence based on the interactive SQL query statement.

In the embodiment of the present application, generating an interactive SQL query statement corresponding to the conditional expression and the word segmentation result based on a plurality of preset SQL statement rule matching templates includes:
firstly, determining, by the server, the plurality of preset SQL statement rule matching templates based on a pre-defined operation of a user. One preset SQL statement rule matching template corresponds to one database query type. The preset SQL statement rule matching template includes slots to be filled for inserting content constituting a database query statement. Subsequently, based on the conditional expression and the word segmentation result, the server matches the corresponding preset SQL statement rule matching template and fills the corresponding slot to be filled to obtain the interactive SQL query statement. Among them, the conditional expression includes a query condition corresponding to the interactive SQL query statement, and the word segmentation result includes a query candidate text corresponding to the query condition and used to construct the interactive SQL query statement.

That is to say, the users may define a series of SQL statement rule matching templates in advance, with each template corresponding to a specific type of query. The templates may protect the basic results of the SQL statements, as well as the specific slots to be filled for inserting specific values (i.e., the content that constitutes the database query statement). For example, for the simple interactive query of “query all employee names”, a template may be defined as follows: “SELECT<column name>FROM<table name>”, where <column name> and <table name> are the slots to be filled that need to be filled based on the actual query content corresponding to the interactive sentence.

The server uses the obtained conditional expressions and the word segmentation results to obtain the specific elements mapped from the keywords in the interactive sentence to the database, including the table name, the column name, the condition value, etc. For example, in the above example of “find employees whose age is greater than 30 years old”, the specific elements mapped to the database may include the table name “employee”, the column name “age”, the condition “greater than”, and the value “30 years old”. The server uses the mapping results and an association list between the mapping results and the preset SQL interactive sentence rule matching templates, it may select one or more preset SQL statement rule matching templates and use the parsing results to fill in the preset SQL statement rule matching templates, to generate the interactive SQL query statements. For example, if the parsing result is the target field of “name” and the table name of “employee”, the filled SQL template is: “SELECT name FROM employee”. In the present application, the preset SQL statement rule matching templates may be customized by users or developers in advance according to actual needs, and the present application does not make specific limitations on this.

Through the above solution, the present application may achieve accurate word segmentation processing of the natural language, ensuring that the interactive sentence may be successfully matched with the fields or the values in the database. At the same time, identifying the conditional expressions in the interactive sentence and their corresponding fields or values in the database may ensure the accuracy of generated interactive SQL query statements and effectively convert the natural language into executable SQL statements. It may also avoid question ambiguity when converting into SQL statements, and achieve generation of SQL statements with complex logic, providing sufficient data preparation conditions for AIGC interaction analysis.

In addition, the present application does not need to manually add synonyms when solving synonym recognition, which improves the efficiency of word segmentation recognition. Through the technical solution of the present application, it may provide the basic conditions for accurate multi-round dialogue in the process of generating AIGC-oriented question and answer content. Compared to generating a complete answer again during continuous questioning, real-time monitoring and updating of the latest answer elements based on the previous answer may reduce the calculation process, improve calculation efficiency, and increase the intelligence of the answer system.

In the embodiment of the present application, the server combines the interactive SQL query statements with the ability of AIGC to answer questions, integrates query content into AIGC answers, and provides interactive response information to a user terminal. The user terminal may be the mobile phone, computer, or other device of the user that sends the interactive sentence, and the present application does not make specific limitations on this.

In the present application, when the method is applied to an AIGC-based conversational BI system, the response process for the interactive sentence in natural language is shown in FIG. 2, which includes text normalization, field/value recognition, conditional recognition (i.e. conditional expression recognition), generating complete SQL and querying (i.e. generating the interactive SQL query statements), and responding by AIGC in natural language.

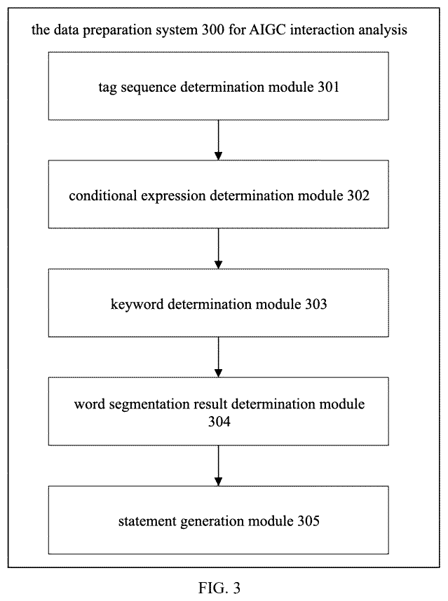

FIG. 3 is a schematic structural diagram of a data preparation system for AIGC interaction analysis according to an embodiment of the present application. As shown in FIG. 3, the data preparation system 300 for AIGC interaction analysis includes:
a tag sequence determination module 301, configured for determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation; a conditional expression determination module 302, configured for determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression; a keyword determination module 303, configured for determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation; a word segmentation result determination module 304, configured for determining a word segmentation result corresponding to the second word segmentation processing based on the exact match keyword and a similar candidate text corresponding to the fuzzy match keyword; and a statement generation module 305, configured for generating an interactive SQL query statement corresponding to the conditional expression and the word segmentation result based on a plurality of preset SQL statement rule matching templates, to determine interactive response information corresponding to the interactive sentence based on the interactive SQL query statement.

In the embodiment of the present application, before determining, by a pre-trained text tag recognition model, a tag sequence corresponding to an interactive sentence after first word segmentation processing, the data preparation system 300 for AIGC interaction analysis is further configured for:
acquiring a text normalization mapping table that is pre-constructed; after receiving the interactive sentence from a user terminal, determining a text to be normalized in the interactive sentence and mapping a text format of the text to be normalized to a standardized format through the text normalization mapping table, to obtain the interactive sentence in the standardized format; wherein the standardized format includes at least a numeric standardized format, a temporal standardized format, a punctuation standardized format, and a reserved part-of-speech standardized format.

In the embodiment of the present application, before determining, by a pre-trained text tag recognition model, a tag sequence corresponding to an interactive sentence after first word segmentation processing, the data preparation system 300 for AIGC interaction analysis is further configured for:
acquiring a statement training sample set that is pre-constructed; wherein the statement training sample set includes at least a plurality of interactive sentence samples and their corresponding SQL query statements, and each of the plurality of interactive sentence samples is pre-annotated with the preset tags used to form the conditional expression; inputting the plurality of interactive sentence samples in the statement training sample set into a text tag recognition model to be trained, so that the text tag recognition model to be trained performs the first word segmentation processing on each of the plurality of interactive sentence samples by its BERT model, and outputs sample prediction tag sequences corresponding to interactive sentence samples after the first word segmentation processing by an output layer; and determining a difference degree value between each of the sample prediction tag sequences and a corresponding true tag sequence by a cross-entropy loss function, until the difference degree value is less than a preset threshold, to obtain a trained text tag recognition model.

In the embodiment of the present application, the keyword determination module 303 is configured for:
performing the second word segmentation processing on the interactive sentence by a HanLP tokenizer, and identifying the second text segmentation that is consistent with the candidate text by the database candidate text dictionary; performing part-of-speech annotation on the second text segmentation that is consistent with the candidate text based on a pre-annotated part of speech corresponding to the candidate text, to obtain the exact match keyword; and regarding second text segmentation that is inconsistent with any candidate text as the fuzzy match keyword.

In the embodiment of the present application, the word segmentation result determination module 304 is configured for:
converting, by a pre-trained word vector model, the fuzzy match keyword into a keyword vector; calculating a text similarity between the keyword vector and a candidate text vector corresponding to each candidate text, and using the text similarity as an input value to input into a preset hierarchical clustering algorithm, to determine a similar candidate text set corresponding to the fuzzy match keyword; filtering each candidate text pair generated from the similar candidate text set and the fuzzy match keyword by a preset filtering rule, to obtain the similar candidate text corresponding to the fuzzy match keyword; and based on the similar candidate text and its corresponding pre-annotated part of speech, as well as the exact match keyword, determining the word segmentation result after performing the second word segmentation processing on the interactive sentence; wherein the word segmentation result includes a query candidate text and its part of speech, and the part of speech includes at least a field and a value.

In the embodiment of the present application, the preset hierarchical clustering algorithm is an Average-Linkage clustering algorithm.

In the embodiment of the present application, the statement generation module 305 is configured for:
determining the plurality of preset SQL statement rule matching templates based on a pre-defined operation of a user; wherein one of the plurality of preset SQL statement rule matching templates corresponds to one database query type, and each of the plurality of preset SQL statement rule matching templates includes a slot to be filled for inserting content constituting a database query statement; and based on the conditional expression and the word segmentation result, matching a corresponding preset SQL statement rule matching template, and filling a corresponding slot to be filled, to obtain the interactive SQL query statement; wherein the conditional expression includes a query condition corresponding to the interactive SQL query statement, and the word segmentation result includes a query candidate text corresponding to the query condition and used to construct the interactive SQL query statement.

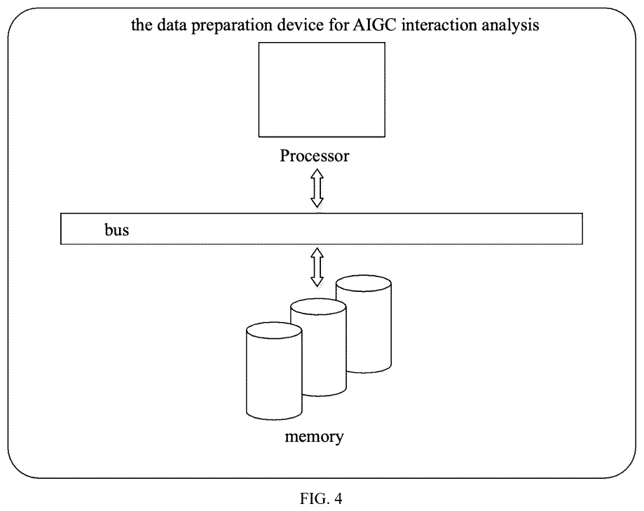

FIG. 4 is a schematic structural diagram of a data preparation device for AIGC interaction analysis according to an embodiment of the present application. As shown in FIG. 4, the device includes:
at least one processor; and a memory connected in communication with the at least one processor; wherein the memory stores an instruction that is capable of being executed by the at least one processor, and the instruction, when executed by the at least one processor, causes the at least one processor to perform operations including:
determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation; determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression; determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation; determining a word segmentation result corresponding to the second word segmentation processing based on the exact match keyword and a similar candidate text corresponding to the fuzzy match keyword; and generating an interactive SQL query statement corresponding to the conditional expression and the word segmentation result based on a plurality of preset SQL statement rule matching templates, to determine interactive response information corresponding to the interactive sentence based on the interactive SQL query statement.

The embodiment of the present application further provides a non-transitory computer storage medium, storing a computer-executable instruction, wherein the computer-executable instruction is configured for:
determining, by a pre-trained text tag recognition model, a tag sequence corresponding to an interactive sentence after first word segmentation processing; wherein the tag sequence includes preset tags that are arranged according to a word order of the interactive sentence and correspond to first text segmentation; determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence has a unique corresponding conditional expression; determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation; determining a word segmentation result corresponding to the second word segmentation processing based on the exact match keyword and a similar candidate text corresponding to the fuzzy match keyword; and generating an interactive SQL query statement corresponding to the conditional expression and the word segmentation result based on a plurality of preset SQL statement rule matching templates, to determine interactive response information corresponding to the interactive sentence based on the interactive SQL query statement.

The various embodiments in the present application are described in a progressive manner, and the same and similar parts between the embodiments may be referred to each other. Each embodiment focuses on the differences from other embodiments. Especially for the embodiments of the system, device, and medium, due to their basic similarity to the method embodiment, the description is relatively simple. For relevant information, please refer to the partial explanation of the method embodiment.

The system, device, and medium correspond one-to-one with the method provided in the embodiments of the present application, therefore, the system, device, and medium also have beneficial technical effects similar to their corresponding methods. As the beneficial technical effects of the methods have been described in detail above, the beneficial technical effects of the system, device, and medium will not be repeated here.

It should also be noted that the terms “comprising/including”, “containing” or any other variation thereof are intended to encompass non-exclusive inclusion, such that a process, method, good or equipment that includes a series of elements not only includes those elements, but also includes other elements not explicitly listed, or also includes elements inherent to such process, method, good or equipment. Without further limitations, the element defined by the statement “including one . . . ” does not exclude the existence of other identical elements in the process, method, product, or device that includes the element in question.

The above description is only an embodiment of the present application and is not intended to limit the present application. For those skilled in the art, the present application may have various modifications and variations. Any modification, equivalent substitution, improvement, etc. made within the spirit and principles of the present application shall be included within the scope of the claims of the present application.

1. A data preparation method for AIGC interaction analysis, comprising:
determining, by a pre-trained text tag recognition model, a tag sequence corresponding to an interactive sentence after first word segmentation processing; wherein the tag sequence comprises preset tags that are arranged according to a word order of the interactive sentence and correspond to first text segmentation;
determining a tag combination sequence corresponding to the tag sequence and a conditional expression corresponding to the tag combination sequence based on a preset expression construction rule; wherein the preset expression construction rule is used to combine a plurality of preset tags in the tag sequence to obtain the tag combination sequence, and each tag combination sequence is associated with a unique corresponding conditional expression;
determining an exact match keyword and a fuzzy match keyword corresponding to the interactive sentence to be subjected to second word segmentation processing by a database candidate text dictionary that is preset and a preset matching rule; wherein the preset matching rule is used to match a candidate text in the database candidate text dictionary that is consistent with second text segmentation;
determining a word segmentation result corresponding to the second word segmentation processing based on the exact match keyword and a similar candidate text corresponding to the fuzzy match keyword; and
generating an interactive structured query language (SQL) query statement corresponding to the conditional expression and the word segmentation result based on a plurality of preset SQL statement rule matching templates, to determine interactive response information corresponding to the interactive sentence based on the interactive SQL query statement;
wherein before determining, by a pre-trained text tag recognition model, a tag sequence corresponding to an interactive sentence after first word segmentation processing, the method further comprises:
acquiring a statement training sample set that is pre-constructed; wherein the statement training sample set comprises at least a plurality of interactive sentence samples and their corresponding SQL query statements, and each of the plurality of interactive sentence samples is pre-annotated with the preset tags used to form the conditional expression;
inputting the plurality of interactive sentence samples in the statement training sample set into a text tag recognition model to be trained, so that the text tag recognition model to be trained performs the first word segmentation processing on each of the plurality of interactive sentence samples by its bidirectional encoder representations from transformers (BERT) model, and outputs sample prediction tag sequences corresponding to interactive sentence samples after the first word segmentation processing by an output layer; and
determining a difference degree value between each of the sample prediction tag sequences and a corresponding true tag sequence by a cross-entropy loss function, until the difference degree value is less than a preset threshold, to obtain a trained text tag recognition model;
wherein the preset expression construction rule comprises an association relationship between the tag combination sequence obtained by combining different preset tags and different conditional expressions.

2. The data preparation method for AIGC interaction analysis according to claim 1, wherein before determining, by a pre-trained text tag recognition model, a tag sequence corresponding to an interactive sentence after first word segmentation processing, the method further comprises:
acquiring a text normalization mapping table that is pre-constructed;
after receiving the interactive sentence from a user terminal, determining a text to be normalized in the interactive sentence and mapping a text format of the text to be normalized to a standardized format through the text normalization mapping table, to obtain the interactive sentence in the standardized format; wherein the standardized format comprises at least a numeric standardized format, a temporal standardized format, a punctuation standardized format, and a reserved part-of-speech standardized format.

3. The data preparation method for AIGC interaction analysis according to claim 1, wherein determining an exact match keyword and a fuzzy match keyword corresponding to the interactive sentence to be subjected to second word segmentation processing by a database candidate text dictionary that is preset and a preset matching rule comprises:
performing the second word segmentation processing on the interactive sentence by a HanLP tokenizer, and identifying the second text segmentation that is consistent with the candidate text by the database candidate text dictionary;
performing part-of-speech annotation on the second text segmentation that is consistent with the candidate text based on a pre-annotated part of speech corresponding to the candidate text, to obtain the exact match keyword; and
regarding second text segmentation that is inconsistent with any candidate text as the fuzzy match keyword.

4. The data preparation method for AIGC interaction analysis according to claim 1, wherein determining a word segmentation result corresponding to the second word segmentation processing based on the exact match keyword and a similar candidate text corresponding to the fuzzy match keyword comprises:
converting, by a pre-trained word vector model, the fuzzy match keyword into a keyword vector;
calculating a text similarity between the keyword vector and a candidate text vector corresponding to each candidate text, and using the text similarity as an input value to input into a preset hierarchical clustering algorithm, to determine a similar candidate text set corresponding to the fuzzy match keyword;
filtering each candidate text pair generated from the similar candidate text set and the fuzzy match keyword by a preset filtering rule, to obtain the similar candidate text corresponding to the fuzzy match keyword; and
based on the similar candidate text and its corresponding pre-annotated part of speech, as well as the exact match keyword, determining the word segmentation result after performing the second word segmentation processing on the interactive sentence; wherein the word segmentation result comprises a query candidate text and its part of speech, and the part of speech comprises at least a field and a value.

5. The data preparation method for AIGC interaction analysis according to claim 4, wherein the preset hierarchical clustering algorithm is an Average-Linkage clustering algorithm.

6. The data preparation method for AIGC interaction analysis according to claim 1, wherein generating an interactive SQL query statement corresponding to the conditional expression and the word segmentation result based on a plurality of preset SQL statement rule matching templates comprises:
determining the plurality of preset SQL statement rule matching templates based on a pre-defined operation of a user; wherein one of the plurality of preset SQL statement rule matching templates corresponds to one database query type, and each of the plurality of preset SQL statement rule matching templates comprises a slot to be filled for inserting content constituting a database query statement; and
based on the conditional expression and the word segmentation result, matching a corresponding preset SQL statement rule matching template, and filling a corresponding slot to be filled, to obtain the interactive SQL query statement; wherein the conditional expression comprises a query condition corresponding to the interactive SQL query statement, and the word segmentation result comprises a query candidate text corresponding to the query condition and used to construct the interactive SQL query statement.

7. (canceled)

8. A data preparation device for AIGC interaction analysis, comprising:
at least one processor; and
a memory connected in communication with the at least one processor; wherein the memory stores an instruction that is capable of being executed by the at least one processor, and the instruction, when executed by the at least one processor, causes the at least one processor to execute operations of the data preparation method for AIGC interaction analysis according to claim 1.

9. A non-transitory computer storage medium, storing a computer-executable instruction, wherein the computer-executable instruction is capable of executing operations of the data preparation method for AIGC interaction analysis according to claim 1.

10. The data preparation method for AIGC interaction analysis according to claim 1, wherein each of the preset tags comprises at least a field name, an operator, and a value.

11. The data preparation method for AIGC interaction analysis according to claim 1, wherein the preset database candidate text dictionary is constructed from all table names, fields, and values in a database.

12. The data preparation method for AIGC interaction analysis according to claim 11, wherein the preset database candidate text dictionary is obtained by:
traversing all tables in the database, extracting the table names, field names, and non-numeric cell values, performing deduplication on the non-numeric cell values, and organizing all the collected information based on a dictionary format required by a HanLP tokenizer.

13. The data preparation method for AIGC interaction analysis according to claim 4, wherein the pre-trained word vector model comprises a Word2Vec model, a global vectors for word representation (GloVe) model, and a BERT model.

14. The data preparation method for AIGC interaction analysis according to claim 4, wherein text similarity is calculated by a formula:
$$cost = \frac{{\sum }_{x = 1}^{y} ( {A}_{x} \times {B}_{x} )}{\sqrt{{\sum }_{x = 1}^{y} {( {A}_{x} )}^{2}} \times \sqrt{{\sum }_{x = 1}^{y} {( {B}_{x} )}^{2}}}$$
where cos t is a cosine similarity between a keyword vector and a candidate text vector, Aₓ represents a component of the keyword vector, Bₓ represents a component of the candidate text vector, and y is a total amount of vector components.

15. The data preparation method for AIGC interaction analysis according to claim 5, wherein the data preparation method further comprises:
calculating an average distance between all possible point pairs between clusters during clustering analysis; and
selecting two clusters with a minimum distance for merging.

16. The data preparation device for AIGC interaction analysis according to claim 8, wherein before determining, by a pre-trained text tag recognition model, a tag sequence corresponding to an interactive sentence after first word segmentation processing, the operations further comprise:
acquiring a text normalization mapping table that is pre-constructed;
after receiving the interactive sentence from a user terminal, determining a text to be normalized in the interactive sentence and mapping a text format of the text to be normalized to a standardized format through the text normalization mapping table, to obtain the interactive sentence in the standardized format; wherein the standardized format comprises at least a numeric standardized format, a temporal standardized format, a punctuation standardized format, and a reserved part-of-speech standardized format.

17. The data preparation device for AIGC interaction analysis according to claim 8, wherein determining an exact match keyword and a fuzzy match keyword corresponding to the interactive sentence to be subjected to second word segmentation processing by a database candidate text dictionary that is preset and a preset matching rule comprises:
performing the second word segmentation processing on the interactive sentence by a HanLP tokenizer, and identifying the second text segmentation that is consistent with the candidate text by the database candidate text dictionary;
performing part-of-speech annotation on the second text segmentation that is consistent with the candidate text based on a pre-annotated part of speech corresponding to the candidate text, to obtain the exact match keyword; and
regarding second text segmentation that is inconsistent with any candidate text as the fuzzy match keyword.

18. The data preparation device for AIGC interaction analysis according to claim 8, wherein determining a word segmentation result corresponding to the second word segmentation processing based on the exact match keyword and a similar candidate text corresponding to the fuzzy match keyword comprises:
converting, by a pre-trained word vector model, the fuzzy match keyword into a keyword vector;
calculating a text similarity between the keyword vector and a candidate text vector corresponding to each candidate text, and using the text similarity as an input value to input into a preset hierarchical clustering algorithm, to determine a similar candidate text set corresponding to the fuzzy match keyword;
filtering each candidate text pair generated from the similar candidate text set and the fuzzy match keyword by a preset filtering rule, to obtain the similar candidate text corresponding to the fuzzy match keyword; and
based on the similar candidate text and its corresponding pre-annotated part of speech, as well as the exact match keyword, determining the word segmentation result after performing the second word segmentation processing on the interactive sentence; wherein the word segmentation result comprises a query candidate text and its part of speech, and the part of speech comprises at least a field and a value.

19. The non-transitory computer storage medium according to claim 9, wherein before determining, by a pre-trained text tag recognition model, a tag sequence corresponding to an interactive sentence after first word segmentation processing, the operations further comprise:
acquiring a text normalization mapping table that is pre-constructed;
after receiving the interactive sentence from a user terminal, determining a text to be normalized in the interactive sentence and mapping a text format of the text to be normalized to a standardized format through the text normalization mapping table, to obtain the interactive sentence in the standardized format; wherein the standardized format comprises at least a numeric standardized format, a temporal standardized format, a punctuation standardized format, and a reserved part-of-speech standardized format.

20. The non-transitory computer storage medium according to claim 9, wherein determining an exact match keyword and a fuzzy match keyword corresponding to the interactive sentence to be subjected to second word segmentation processing by a database candidate text dictionary that is preset and a preset matching rule comprises:
performing the second word segmentation processing on the interactive sentence by a HanLP tokenizer, and identifying the second text segmentation that is consistent with the candidate text by the database candidate text dictionary;
performing part-of-speech annotation on the second text segmentation that is consistent with the candidate text based on a pre-annotated part of speech corresponding to the candidate text, to obtain the exact match keyword; and
regarding second text segmentation that is inconsistent with any candidate text as the fuzzy match keyword.

21. The non-transitory computer storage medium according to claim 9, wherein determining a word segmentation result corresponding to the second word segmentation processing based on the exact match keyword and a similar candidate text corresponding to the fuzzy match keyword comprises:
converting, by a pre-trained word vector model, the fuzzy match keyword into a keyword vector;
calculating a text similarity between the keyword vector and a candidate text vector corresponding to each candidate text, and using the text similarity as an input value to input into a preset hierarchical clustering algorithm, to determine a similar candidate text set corresponding to the fuzzy match keyword;
filtering each candidate text pair generated from the similar candidate text set and the fuzzy match keyword by a preset filtering rule, to obtain the similar candidate text corresponding to the fuzzy match keyword; and
based on the similar candidate text and its corresponding pre-annotated part of speech, as well as the exact match keyword, determining the word segmentation result after performing the second word segmentation processing on the interactive sentence; wherein the word segmentation result comprises a query candidate text and its part of speech, and the part of speech comprises at least a field and a value.
